(19) United States
(12) Patent Application Publication
(10) Pub. No.: US 2024/0410916 A1
(43) Pub. Date: Dec. 12, 2024

(54) FRICTION REGULATION METHOD, APPARATUS AND SYSTEM FOR MOLYBDENUM DISULFIDE

(71) Applicant: Tsinghua University, Beijing City (CN)

(72) Inventors: Dameng Liu, Beijing City (CN); Liang Fang, Beijing City (CN); Hua Pang, Beijing City (CN); Huixian Liu, Beijing City (CN); Jianbin Luo, Beijing City (CN)

(21) Appl. No.: 18/715,090

(22) PCT Filed: Nov. 21, 2019
(86) PCT No.: PCT/CN2019/119895

§ 371 Date: May 30, 2024

(30) Foreign Application Priority Data
Sep. 23, 2019 (CN) 201910899712.4

(51) Int. Cl. G01Q 60/26; C10M 107/00; G01N 23/2251

(52) U.S. Cl. CPC G01Q 60/26; G01N 23/2251; C10M 7/00; C10M 2201/0663

(57) ABSTRACT

The disclosure provides a friction regulation method, apparatus and system for molybdenum disulfide. The method includes: acquiring frictional force data of a friction pair corresponding to the molybdenum disulfide under different electron beam irradiation conditions, and the different electron beam irradiation conditions includes different accelerating voltage conditions and different electron beam current conditions; acquiring frictional characteristic data of the molybdenum disulfide based on the frictional force data of the friction pair corresponding to the molybdenum disulfide under the different electron beam irradiation conditions; and controlling, after acquiring a target frictional force of the molybdenum disulfide, an electron beam to irradiate the molybdenum disulfide based on the frictional characteristic data of the molybdenum disulfide, to regulate a frictional force of the friction pair corresponding to the molybdenum disulfide to the target frictional force.

### TECHNICAL FIELD

The disclosure relates to the technical field of friction energy dissipation, and in particular to a friction regulation method, apparatus and system for molybdenum disulfide.

### BACKGROUND

As a widespread energy dissipation process when two surfaces under contact slide against each other, friction and its regulation method have received increasing attention in recent years, and play a key role in the study of Micro-Electro Mechanical systems (MEMS) and tribological mechanisms. In nano-scale friction, when the friction pair is insulators, the kinetic energy of the friction pair is dissipated only by phonon emission (i.e., lattice vibration). However, if the friction pair is conductive, friction energy dissipation can also occur through electron channels. Therefore, by modulating the surface electronic characteristics, the electron channels for friction energy dissipation and frictional characteristics may be regulated.

Many scholars have tried to regulate electron channels for friction energy dissipation by electrical means so as to regulate the surface friction characteristics. A typical method is to apply a bias voltage between the friction pair and measure the changes in frictional force under the applied bias voltage using an Atomic Force Microscope (AFM). By scanning the Si p-n junction under bias voltage using an atomic force microscope probe, Park et al. observes higher friction in the high doping p-region with relatively high carrier density. Yabing conducts similar studies on the relationship between carrier density and friction for n-type GaAs, and observes a similar increase in friction. Lately, there is a method to study the change in friction based on the characteristic that the carrier density and conductivity vary in a wide range during metal-insulator transition of vanadium dioxide (VO₂). This method shows that there is a significant correlation between surface friction and carrier density. However, considering the electron and phonon mechanisms of the associated friction energy dissipation, these changes in friction are attributed to be caused by electrostatic force due to the charge trapping effect, and friction regulation using this method is interfered with by electrostatic force on the surfaces of the friction pair, so that the accuracy of friction regulation is affected.

### SUMMARY

An embodiment of the disclosure provides a friction regulation method for molybdenum disulfide, which is used for performing friction regulation on the molybdenum disulfide to avoid interference of electrostatic force and have high accuracy. The method includes:
acquiring frictional force data of a friction pair corresponding to the molybdenum disulfide under different electron beam irradiation conditions, and the different electron beam irradiation conditions includes different accelerating voltage conditions and different electron beam current conditions;
acquiring frictional characteristic data of the molybdenum disulfide based on the frictional force data of the friction pair corresponding to the molybdenum disulfide under the different electron beam irradiation conditions; and
controlling, after acquiring a target frictional force of the molybdenum disulfide, an electron beam to irradiate the molybdenum disulfide based on the frictional characteristic data of the molybdenum disulfide, to regulate a frictional force of the friction pair corresponding to the molybdenum disulfide to the target frictional force.

An embodiment of the disclosure provides a friction regulation apparatus for molybdenum disulfide, which is used for performing friction regulation on the molybdenum disulfide to avoid interference of electrostatic force and have high accuracy. The apparatus includes:
a frictional force data acquisition module configured to acquire frictional force data of a friction pair corresponding to the molybdenum disulfide under different electron beam irradiation conditions, and the different electron beam irradiation conditions includes different accelerating voltage conditions and different electron beam current conditions;
a frictional characteristic data acquisition module configured to acquire frictional characteristic data of the molybdenum disulfide based on the frictional force data of the friction pair corresponding to the molybdenum disulfide under the different electron beam irradiation conditions; and
a regulation module configured to control, after acquiring a target frictional force of the molybdenum disulfide, an electron beam to irradiate the molybdenum disulfide based on the frictional characteristic data of the molybdenum disulfide, to regulate a frictional force of the friction pair corresponding to the molybdenum disulfide to the target frictional force.

An embodiment of the disclosure provides a friction regulation system for molybdenum disulfide, which is used for performing friction regulation on the molybdenum disulfide to avoid interference of electrostatic force and have high accuracy. The friction regulation system includes: the above friction regulation apparatus for molybdenum disulfide, an atomic force microscope and a scanning electron microscope.

The atomic force microscope is configured to acquire frictional force data between the molybdenum disulfide and an atomic force microscope probe under different electron beam irradiation conditions by moving the atomic force microscope probe on a surface of the molybdenum disulfide at a set scanning speed, and send the frictional force data to the friction regulation apparatus for molybdenum disulfide.

The scanning electron microscope is configured to receive an electron beam control command and emit an electron beam according to the electron beam control command. The electron beam control command includes different electron beam irradiation conditions.

The friction regulation apparatus for molybdenum disulfide is further configured to send the electron beam control command to the atomic force microscope and receive the frictional force data.

An embodiment of the disclosure further provides a computer device, including a memory, a processor and a computer program stored in the memory and executable on the processor. When executing the computer program, the processor implements the friction regulation method for molybdenum disulfide.

An embodiment of the disclosure further provides a computer-readable storage medium, storing the computer program for executing the friction regulation method for molybdenum disulfide.

In the embodiments of the disclosure, the frictional force data of the friction pair corresponding to the molybdenum disulfide under the different electron beam irradiation conditions are acquired. The different electron beam irradiation conditions include different accelerating voltage conditions and different electron beam current conditions. The frictional characteristic data of the molybdenum disulfide are acquired based on the frictional force data of the friction pair corresponding to the molybdenum disulfide under the different electron beam irradiation conditions. After acquiring the target frictional force of the molybdenum disulfide, the electron beam is controlled to irradiate the molybdenum disulfide based on the frictional characteristic data of the molybdenum disulfide, to regulate the frictional force of the friction pair corresponding to the molybdenum disulfide to the target frictional force. In the above process, the frictional characteristic data of the molybdenum disulfide are acquired based on the frictional force data of the friction pair corresponding to the molybdenum disulfide under the different electron beam irradiation conditions; and then, after acquiring the target frictional force of the molybdenum disulfide each time, the electron beam can be controlled to irradiate the molybdenum disulfide based on the frictional characteristic data of the molybdenum disulfide, to regulate the frictional force of the friction pair corresponding to the molybdenum disulfide to the target frictional force. The implementation of the friction regulation process for molybdenum disulfide by irradiating the molybdenum disulfide with the electron beam is not interfered with the electrostatic force on the surface of the friction pair, so the regulation accuracy is high.

### BRIEF DESCRIPTION OF THE DRAWINGS

In order to more clearly illustrate the embodiments of the disclosure or the technical solutions in the prior art, the drawings to be used in the description of the embodiments or the prior art will be briefly described below, Obviously, the drawings in the following description are only some embodiments of the disclosure, and those skilled in the art may obtain other drawings according to these drawings without any inventive work. In the drawings:

FIG. 1 is a flowchart of a friction regulation method for molybdenum disulfide according to an embodiment of the disclosure;

FIG. 2 shows schematic diagrams showing a measuring process of frictional force data of a friction pair corresponding to molybdenum disulfide under an electron beam irradiation condition according to an embodiment of the disclosure;

FIG. 3 shows schematic diagrams of data collection by an atomic force microscope according to an embodiment of the disclosure;

FIG. 4 are schematic diagrams showing frictional characteristic analysis of single-layer molybdenum disulfide according to an embodiment of the disclosure;

FIG. 5 is a schematic diagram of measured average adhesive forces according to an embodiment of the disclosure:

FIG. 6 shows a relationship between a relative frictional force of single-layer molybdenum disulfide, and an accelerating voltage and an electron beam current according to an embodiment of the disclosure:

FIG. 7 shows a relationship between a relative frictional force of double-layer molybdenum disulfide, and an accelerating voltage and an electron beam current according to an embodiment of the disclosure;

FIG. 8 is a schematic diagram showing a relationship between a relative frictional force of single-layer molybdenum disulfide and friction time according to an embodiment of the disclosure,

FIG. 9 is a schematic diagram of a friction regulation apparatus for molybdenum disulfide according to an embodiment of the disclosure; and

FIG. 10 is a schematic diagram of a friction regulation system for molybdenum disulfide according to an embodiment of the disclosure.

### DESCRIPTION OF THE EMBODIMENTS

In order to make the objectives, technical solutions and advantages of the embodiments of the disclosure clearer, the embodiments of the disclosure will be further illustrated in further detail below in conjunction with the drawings. Here, the exemplary embodiments of the disclosure and descriptions thereof are used to illustrate the disclosure, but are not intended to limit the disclosure.

In the description of this specification, “include” “comprise”, “have” and “contain” are all open terms, i.e., they mean including but not limited to. Descriptions with reference to the terms “one embodiment” “one specific embodiment”, “some embodiments” and “for example” mean that specific features, structures or characteristics described in conjunction with this embodiment or example are included in at least one embodiment or example of this application. In this specification, the schematic expressions of the above terms do not necessarily refer to the same embodiment or example. Furthermore, the specific features, structures or characteristics described may be combined in a suitable manner in any one or more embodiments or examples. The sequence of steps involved in each embodiment is used to schematically illustrate the implementation of this application, and the sequence of steps is not limited, and may be appropriately regulated as needed.

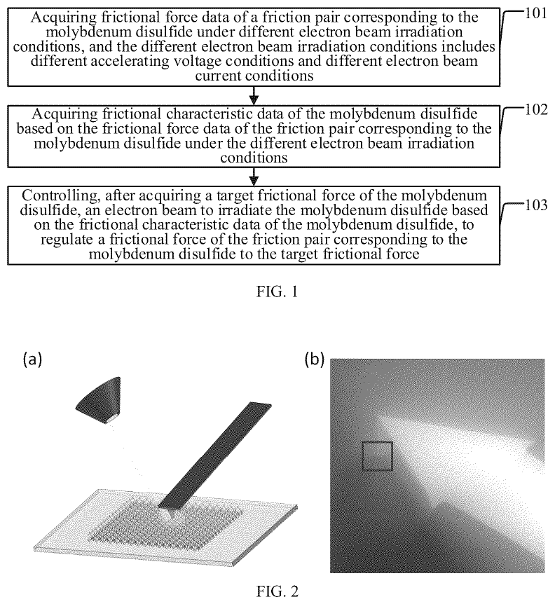

FIG. 1 is a flowchart of a friction regulation method for molybdenum disulfide according to an embodiment of the disclosure. As shown in FIG. 1, the method includes:
Step 101: Acquiring frictional force data of a friction pair corresponding to the molybdenum disulfide under different electron beam irradiation conditions, and the different electron beam irradiation conditions includes different accelerating voltage conditions and different electron beam current conditions.
Step 102: Acquiring frictional characteristic data of the molybdenum disulfide based on the frictional force data of the friction pair corresponding to the molybdenum disulfide under the different electron beam irradiation conditions.
Step 103: Controlling, after acquiring a target frictional force of the molybdenum disulfide, an electron beam to irradiate the molybdenum disulfide based on the frictional characteristic data of the molybdenum disulfide to regulate a frictional force of the friction pair corresponding to the molybdenum disulfide to the target frictional force.

In the embodiment of the disclosure, the frictional characteristic data of the molybdenum disulfide are acquired based on the frictional force data of the friction pair corresponding to the molybdenum disulfide under the different electron beam irradiation conditions; and then, after acquiring the target frictional force of the molybdenum disulfide each time, the electron beam can be controlled to irradiate the molybdenum disulfide based on the frictional characteristic data of the molybdenum disulfide, to regulate the frictional force of the friction pair corresponding to the molybdenum disulfide to the target frictional force. The implementation of the friction regulation process for molybdenum disulfide by irradiating the molybdenum disulfide with the electron beam is not interfered with the electrostatic force on the surface of the friction pair, so the regulation accuracy is high.

During specific implementation, before step 101, the molybdenum disulfide, i.e. the molybdenum disulfide sample, needs to be acquired. In a manner analogous to graphene production, bulk molybdenum disulfide may be mechanically exfoliated onto a SiO₂/Si (SiO₂:300 nm) substrate under an atmospheric environment, and the molybdenum disulfide is made to have as clean and atomically flat a surface as possible. The thickness of the molybdenum disulfide may be determined by an optical microscope, and the accurate thickness of the molybdenum disulfide may be further acquired by Raman spectra. In friction measurement in the subsequent step, the molybdenum disulfide is in an ultra-high vacuum chamber (under an ultra-high Vacuum of about 10⁻⁸ Pa) to prevent the molybdenum disulfide from absorbing gas and avoid oxidation of the molybdenum disulfide.

In an embodiment, the friction pair corresponding to the molybdenum disulfide is a friction pair formed between the molybdenum disulfide and an atomic force microscope probe.

In the above embodiment, the atomic force microscope (AFM) probe may be a silicon probe with a conductive metal layer to avoid charge accumulation at the end of the probe and improve measurement accuracy of the frictional force data. For example, a silicon probe Olympus & Asylum AC240TM-R3 may be used, which has a probe radius of R=5 to 10 nm and a typical normal force constant of k≈2 N/m.

FIG. 2 shows schematic diagrams showing a measuring process of frictional force data of the friction pair corresponding to the molybdenum disulfide under electron beam irradiation conditions according to an embodiment of the disclosure. As shown in FIG. 2, FIG. 2(a) is a schematic measurement diagram. A scanning electron microscope may be used to emit the electron bean. Specifically, an electron beam emitter (also called an electron gun) of the scanning electron microscope is used to emit the electron beam. The electron beam emitter is provided on the surface of the molybdenum disulfide with an inclination angle of 45 degrees, and points directly at a contact region of the molybdenum disulfide and the AFM probe, i.e., directly at the friction pair corresponding to the molybdenum disulfide. During measurement, a predetermined load is applied to the AFM probe and the AFM probe is controlled to move at a set scanning speed in a direction perpendicular to the AFM cantilever, to acquire lateral force signals in two directions. The lateral force signals in the two directions are subtracted to obtain the frictional force. At the same time, when the AFM probe moves on the surface of the molybdenum disulfide at the set scanning speed, the scanning electron microscope (SEM) intensively irradiates the end of the AFM probe, as shown in FIG. 2(b), so that the electron beam from the electron beam emitter irradiates the contact region of the molybdenum disulfide and the AFM probe, thereby achieving the electron beam irradiation of the friction pair. In addition, the electron beam emitter of the SEM may emit the electron beam according to a received electron beam control command. The electron beam control command includes an accelerating voltage of the irradiating electron beam and an electron beam current of the irradiating electron beam.

During specific implementation, the frictional force data obtained by the method of the embodiment of the disclosure is sent by the AFM. Specifically, the frictional force data are generally frictional force morphologies, and the AFM may also collect height morphologies of the molybdenum disulfide, morphologies of current flowing through the AFM probe, etc. An embodiment of the AFM measuring the changes in frictional force will be given below.

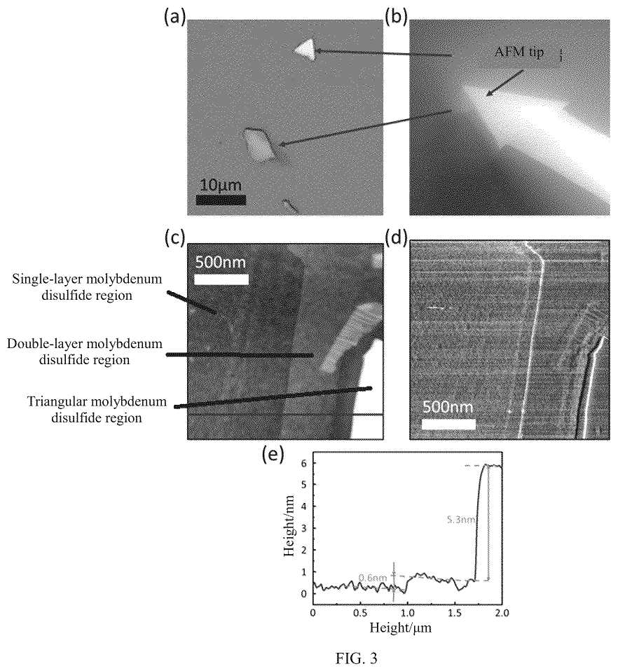

FIG. 3 shows schematic diagrams of data collection by an atomic force microscope according to an embodiment of the disclosure, FIG. 3(a) shows the molybdenum disulfide. FIG. 3(b) shows a SEM image of the friction pair formed by the molybdenum disulfide and the atomic force microscope probe. As can be seen, the molybdenum disulfide in FIG. 3(a) included 3 regions, namely a single-layer molybdenum disulfide region, a double-layer molybdenum disulfide region and a triangular molybdenum disulfide region, and the AFM probe had been accurately located on the double-layer molybdenum disulfide region of the molybdenum disulfide. FIG. 3(c) is a height morphology of the molybdenum disulfide, which clearly shows heights of the single-layer molybdenum disulfide region, the double-layer molybdenum disulfide region and the triangular molybdenum disulfide region that are separated by distinct boundaries. FIG. 3(e) is a height profile of the molybdenum disulfide. As can be seen, the height step of the single-layer molybdenum disulfide region and the double-layer molybdenum disulfide region is 0.6 nm, which is consistent with the intrinsic interlayer crystal spacing, and the height steps of the double-layer molybdenum disulfide region and the triangular molybdenum disulfide region is 5.3 nm, FIG. 3(d) is a frictional force morphology of the molybdenum disulfide. As can be seen, there are significant boundaries between the single-layer molybdenum disulfide region, the double-layer molybdenum disulfide region and the triangular molybdenum disulfide region, which indicates that frictional forces in the three regions were different. The frictional force decreased monotonously with the increase of the thickness of the molybdenum disulfide, which is related to the puckering effect.

During specific implementation, it is required to acquire the frictional force data of the friction pair corresponding to the molybdenum disulfide under the different electron beam irradiation conditions. The frictional force data are used for acquiring the frictional characteristic data of the molybdenum disulfide, so that the electron beam is controlled to irradiate the molybdenum disulfide, thereby regulating the frictional force of the friction pair corresponding to the molybdenum disulfide to the target frictional force. Therefore, the disclosure analyzed changes of frictional force data of single-layer molybdenum disulfide and the double-layer molybdenum disulfide under electron beam irradiation.

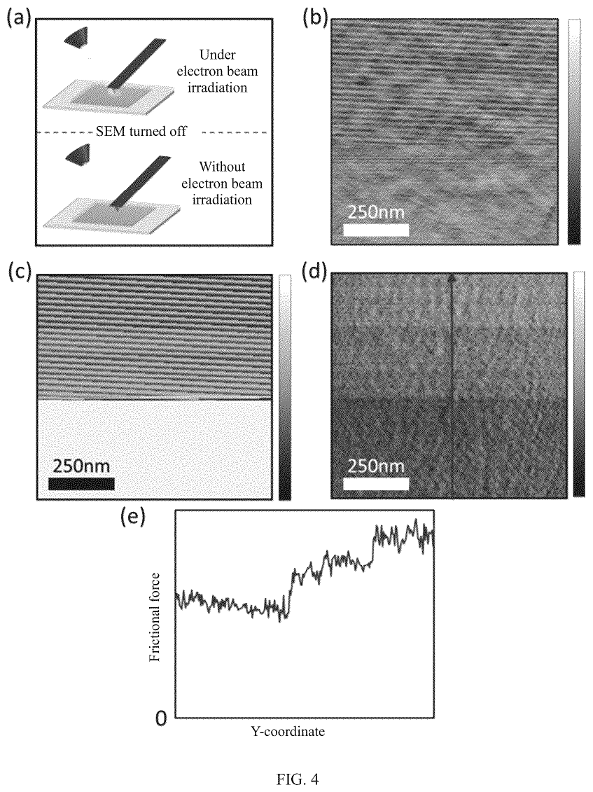

FIG. 4 are schematic diagrams showing frictional characteristic analysis of single-layer molybdenum disulfide according to an embodiment of the disclosure. FIG. 4(a) is a schematic diagram showing electron beam irradiation, where the upper part is a schematic measurement diagram of the single-layer molybdenum disulfide under electron beam irradiation, and accelerating voltage of the electron beam and electron beam current of the electron beam are respectively set at 20 kV and 50 nA, and the lower part is a schematic measurement diagram of the single-layer molybdenum disulfide without electron beam irradiation. Under the above two sets of electron beam irradiation conditions, when the AFM probe moves on the surface of the molybdenum disulfide at a set scanning speed, frictional force morphologies between the molybdenum disulfide and the AFM probe, morphologies of current flowing through the AFM probe, and height morphologies of the molybdenum disulfide, respectively as shown in FIGS. 4(b), (c) and (d), are acquired. In FIG. 4(b), the upper part is the height morphology of the single-layer molybdenum disulfide under electron beam irradiation, and the lower part is the height morphology of the single-layer molybdenum disulfide without electron beam irradiation. As can be seen, the upper part shows periodic stripes, which are speculated to be caused by the interference of periodic scanning of the electron beam on the AFM probe. In FIG. 4(c), the upper part is the morphology of current under electron beam irradiation, and the lower part is the morphology of current without electron beam irradiation. As can be seen, without electron beam irradiation, the current flowing through the AFM probe is approximately zero (less than 20 pA), which indicates that there is no electron beam irradiation. Under electron beam irradiation, the current of the AFM probe is about −3 nA, which proves that there is electron injection. However, this current is much lower than the set beam current (50 nA) of the irradiating electron beam. It is speculated that this is because the thickness of the oxide layer on the silicon substrate is only 270 nm, so most of the injected electrons flows through the single-laver molybdenum disulfide, or this is the result of secondary electron emission. In addition, similar height morphology stripes induced by periodic scanning could also be detected in this morphology, which proves the speculation that part of the injected electrons flows through the single-layer molybdenum disulfide and the substrate. In FIG. 4, the upper part is the frictional force morphology under electron beam irradiation, and the lower part is the frictional force morphology without electron beam irradiation. As can be seen, the frictional force between the single-layer molybdenum disulfide and the AFM probe significantly increases under electron beam irradiation. FIG. 4(e) is a vertical profile showing the friction morphology. As can be seen, under electron beam irradiation, the frictional force between the single-layer molybdenum disulfide and the AFM probe increases by about 40%. As can be seen from FIG. 4(d), no similar height morphology stripes induced by periodic scanning are detected in the friction morphology, which means that the electron beam irradiation had no effect on the contact state of the friction pair. When the above measurements are repeated by applying different loads ranging from 5 nN to 25 nN to the AFM probe and controlling the AFM probe to move at a scanning speed of 0.5 um/s to 2 um/s in a direction perpendicular to the AFM cantilever, it is also found that the frictional force significantly increases under electron beam irradiation.

Then, the above measuring process is performed on the double-layer molybdenum disulfide, and it is found that the electron beam irradiation almost had no effect on the friction of the double-layer molybdenum disulfide.

In order to further analyze the frictional characteristics of the molybdenum disulfide, an embodiment of the disclosure analyzes the reasons for the increase of frictional force under electron beam irradiation. First, several possible external factors are analyzed, and the several possible external factors includes electron beam scanning period, roughness of molybdenum disulfide, carbon deposition on the surface of molybdenum disulfide and electrostatic force on the surface of the friction pair.

Effect of electron beam scanning period on increase of frictional force: during the measurement of the molybdenum disulfide, the SEM is used to apply the electron beam irradiation, and the position of the electron injection is constantly changed, which may lead to the instability of friction. In view of this, the scanning area of the electron beam is set to be as small as possible, and the scanning frequency of the electron beam is very high. This results in a relatively short electron beam scanning period (<0.3 s), which is much faster than the scanning of the AFM probe. Therefore, it is considered that the effect of periodic scanning could be ignored by using the average friction value under the electron beam irradiation, that is, the electron beam scanning period has no effect on the increase of friction.

Effect of roughness of molybdenum disulfide on increase of frictional force: in this embodiment of the disclosure, the roughness of the surface of the molybdenum disulfide with and without electron beam irradiation are measured and calculated, and it is found that there is no difference. Therefore, the roughness of the molybdenum disulfide has no effect on the increase of the frictional force.

Effect of carbon deposition on surface of molybdenum disulfide on increase of frictional force: in the implementation of the disclosure, no carbon deposition is found during the above measurement process, and all the measurements has been repeated for more than four times, so the effect of carbon deposition could be ruled out, Considering that all the measurements are carried out under an ultra-high vacuum environment, carbon deposition should have been suppressed, so the carbon deposition on the surface of the molybdenum disulfide has no effect on the increase of the frictional force.

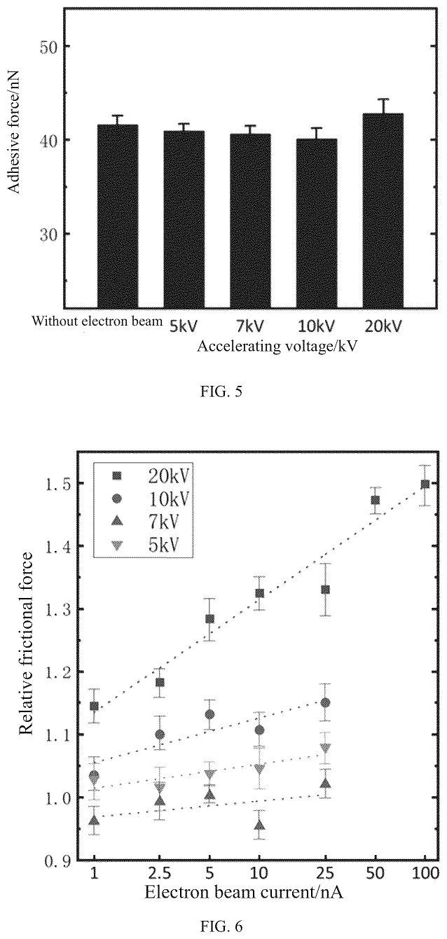

Effect of electrostatic force on surface of friction pair on increase of frictional force: the electrostatic force on the surface of the friction pair is caused by contact electrification and static electricity. Considering that the electrostatic force often leads to the increase of the adhesive force between the AFM probe and the molybdenum disulfide, this embodiment of the disclosure studies the effect of the electrostatic force by measuring the adhesive force between the single-layer molybdenum disulfide and the AFM probe through single-force indentation under different electron beam irradiation conditions. During the measurement, under any accelerating voltage, the electron beam current is set at 25 nA. FIG. 5 is a schematic diagram of measured average adhesive forces according to an embodiment of the disclosure. FIG. 5(a) includes the case of the accelerating voltage without electron beam irradiation and the case of different accelerating voltages under electron beam irradiation. Obviously, it could be found that the adhesive force only slightly changed (<5%) under different accelerating voltages, which indicates that the effect of the electron beam irradiation on the adhesive force is negligible. The reason for the insensitivity of adhesion to the electron beam irradiation may be the use of the minimum electron beam current in the measurement, because the maximum electron beam current is only 100 nA during the measurement in this embodiment of the disclosure, which is much smaller than the conductivity of the probe friction pair conducted by the molybdenum disulfide. Therefore, the electron beam irradiation could not lead to significant charge accumulation in the friction pair and electrostatic force on the surface of the friction pair. This insensitivity of adhesion indicates that the increase of friction under electron beam irradiation is not caused by electrostatic force. Through the SEM image obtained during the measurement, it was also found that no spark caused by charge accumulation is observed.

In addition, this insensitivity of adhesive force to the electron beam irradiation also rules out the possibility that the electron beam irradiation affects friction through the puckering effect, because the puckering effect may lead to different actual contact areas and thus to different adhesive forces.

After ruling out the effect of these external factors, this embodiment of the disclosure infers that this increase of friction under electron beam irradiation is related to the change of intrinsic frictional characteristics of the molybdenum disulfide. Considering that under electron beam irradiation, the frictional force of the single-layer molybdenum disulfide increases significantly but the frictional force of the double-layer molybdenum disulfide not changes significantly, the difference between the single-layer molybdenum disulfide and the double-layer molybdenum disulfide is the key to study the increase of frictional force in this embodiment of the disclosure. Recent studies show that the single-layer molybdenum disulfide and the double-layer molybdenum disulfide have similar lattice structures and mechanical properties but have different energy-band structures. The single-layer molybdenum disulfide has a direct band gap, and the double-layer molybdenum disulfide has an indirect band gap. Different energy-band structures lead to completely different exciton dynamics, which has been confirmed by recent experiments and simulations. Moreover, it has been widely reported that electron beam irradiation can excite carriers in semiconductors including small amounts of molybdenum disulfide. Therefore, in this embodiment of the disclosure, it is speculated that different changes in frictional force of the single-layer molybdenum disulfide and the double-layer molybdenum disulfide under electron beam irradiation are due to different band structures, and it is deduced that this increase of friction under electron beam irradiation is related to the increase of excited electrons. On the single-layer molybdenum disulfide with the direct band gap, electrons could be easily excited under electron beam irradiation, thereby increasing the number of the excited electrons. On the double-layer molybdenum disulfide, due to the indirect band gap, it is relatively hard to excite electrons under electron beam irradiation. Based on these analyses, in this embodiment of the disclosure, it is speculated that the increase of frictional force on the single-layer molybdenum disulfide under electron beam irradiation is due to the increase of the excited electrons.

Based on this conclusion, in an embodiment of the disclosure, the molybdenum disulfide is single-layer molybdenum disulfide.

In the above embodiment, the controlling the electron bean to irradiate the molybdenum disulfide based on the frictional characteristic data of the molybdenum disulfide, to regulate the frictional force of the friction pair corresponding to the molybdenum disulfide to the target frictional force in step 103 is to control the electron beam to irradiate the single-layer molybdenum disulfide based on the frictional characteristic data of the single-layer molybdenum disulfide, to regulate the single-layer molybdenum disulfide, i.e., only the single-layer molybdenum disulfide is used as the object of friction regulation in this embodiment of the disclosure.

After the frictional characteristics of the molybdenum disulfide are obtained, the frictional force data of the friction pair corresponding to the molybdenum disulfide under different electron beam irradiation conditions are obtained for subsequent regulation. During specific implementation, there are many methods to obtain the frictional force data of the friction pair corresponding to the molybdenum disulfide under different electron beam irradiation conditions, and one embodiment is given below.

In an embodiment, the acquiring the frictional force data of the friction pair corresponding to the molybdenum disulfide under the different electron beam irradiation conditions includes:
acquiring a plurality of sets of electron beam irradiation conditions;
controlling, for each set of electron beam irradiation conditions, an accelerating voltage of a scanning electron microscope and an electron beam current thereof to meet the set of electron beam irradiation conditions; and
acquiring, when the atomic force microscope probe moves at a set scanning speed on a surface of the molybdenum disulfide, the frictional force data between the molybdenum disulfide and the atomic force microscope probe under each set of electron beam irradiation conditions.

In the above embodiment, in order to eliminate the deviation caused by regional deviation, the relative frictional force is defined as a ratio of a first frictional force and a second frictional force on a set molybdenum disulfide region. The first frictional force is the frictional force between the molybdenum disulfide and the AFM probe under electron beam irradiation, and the second frictional force is the frictional force between the molybdenum disulfide and the AFM probe without electron beam irradiation. The frictional force data acquired subsequently may be expressed in terms of relative frictional force.

Limited by the regulation range of the electron emitter, the accelerating voltage is regulated in the range of 5 kV to 20 kV, thereby forming a plurality of accelerating voltage conditions; and the electron beam current is regulated in the range of 1 nA to 100 nA, thereby forming a plurality of electron beam current conditions. The friction measurement parameters of the AFM are set at a load of 10 nN and a scanning speed of 1 μm/s. The above data can form a plurality of sets of electron beam irradiation conditions, and each set of electron beam irradiation conditions includes one accelerating voltage condition and one electron beam current condition. For each set of electron beam irradiation conditions, an accelerating voltage of the scanning electron microscope and an electron beam current of the scanning electron microscope are controlled to meet the set of electron beam irradiation conditions; and when the atomic force microscope probe moves at the set scanning speed on the surface of the molybdenum disulfide, the frictional force data between the molybdenum disulfide and the atomic force microscope probe under each set of electron beam irradiation conditions are acquired.

In an embodiment, the frictional characteristic data of the molybdenum disulfide includes a relationship between the frictional force data, and the accelerating voltage and the electron beam current.

The acquiring the frictional characteristic data of the molybdenum disulfide based on the frictional force data of the friction pair corresponding to the molybdenum disulfide under the different electron beam irradiation conditions includes:
obtaining the relationship between the frictional force data, and the accelerating voltage and the electron beam current based on the frictional force data between the molybdenum disulfide and the atomic force microscope probe under the plurality of sets of electron beam irradiation conditions.

In the above embodiment, based on the frictional force data between the molybdenum disulfide and the AFM probe under the plurality of sets of electron beam irradiation conditions, the relationship between the frictional force data, and the accelerating voltage and the electron beam current can be obtained. The frictional force data may be the relative frictional force. That is, the relationship between the relative frictional force, and the accelerating voltage and the electron beam current can be obtained. The relationship may be expressed in many forms, such as text, tables and graphs. FIG. 6 shows the relationship between the relative frictional force of the single-laver molybdenum disulfide, and the accelerating voltage and the electron beam current according to an embodiment of the disclosure. Obviously, it could be found that the relative friction force is greater than 1.0 under electron beam irradiation, which means that the frictional force between the single-layer molybdenum disulfide and the AFM probe increases under electron beam irradiation, Under the electron beams irradiation with different accelerating voltages and different beam currents, the relative frictional force varies greatly. When the accelerating voltage is 5 kV or 7 kV, the relative frictional force is slightly greater than 1.0 (smaller than 1.1), and is even smaller than 1.0 under some conditions. The relative frictional force being only slightly greater than 1.0 means that the effect of the electron beam irradiation is almost negligible. However, when the accelerating voltage is 10 kV or 20 kV, the relative frictional force is significantly greater than 1.0, and monotonously increased with increasing electron beam current. Under the electron beam irradiation with the accelerating voltage of 10 kV when the electron beam current increases from 1 nA to 25 nA, the relative frictional force increases from 1.05 to 1.15, which means that the magnitude of increase of the frictional force is increased from 5% to 15%. Under the electron beam irradiation with the accelerating voltage of 20 kV when the electron beam current increases from 1 nA to 100 nA, the relative frictional force increases from 1.15 to 1.45, which means that the magnitude of increase of the frictional force is increased from 15% to 45%. This result indicates that the friction between the molybdenum disulfide and the AFM probe increases under electron beam irradiation, and the degree of increase increases with the accelerating voltage and the electron beam current. The frictional force of the molybdenum disulfide may be regulated based on the above relationship.

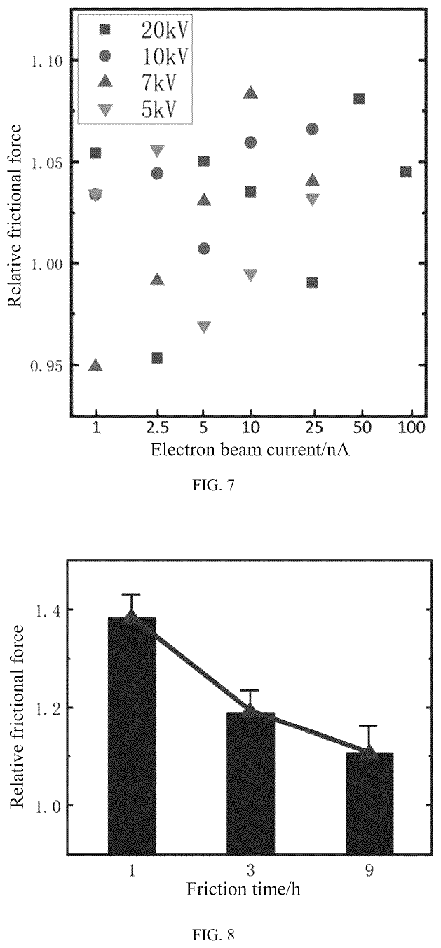

In addition, as a comparison, in another embodiment of the disclosure, the measurement is repeated on the double-layer molybdenum disulfide. FIG. 7 shows a relationship between the relative frictional force of double-layer molybdenum disulfide, and the accelerating voltage and the electron beam current in an embodiment of the disclosure. As can be seen, the relative friction is in the range of 0.95 to 1.1 regardless of the accelerating voltage and the electron beam current. Considering the interference of the measurement error of frictional force and the electron beam, this unordered relative frictional force being only slightly greater than 1.0 means that the electron beam irradiation almost has no effect on the friction on the double-laver molybdenum disulfide.

In another embodiment, the frictional characteristic data of the molybdenum disulfide further includes a relationship between the frictional force data of the single-layer molybdenum disulfide and friction time. The frictional force data may also be expressed in terms of relative frictional force.

FIG. 8 is a schematic diagram showing the relationship between the relative frictional force of single-laver molybdenum disulfide and friction time according to an embodiment of the disclosure. The friction time is measured under an electron beam irradiation with an accelerating voltage of 20 kV and a beam current of 50 nA When a new AFM probe is used, the relative frictional force is relatively high, and under electron beam irradiation, the frictional force on the single-layer molybdenum disulfide increases significantly. With the increase of the friction time, the relative frictional force gradually decreases, After more than 9 h of friction time, the relative frictional force decreases to about 1.1. It is deduced that this phenomenon is due to the gradual change in the configuration of the AFM probe. With the increase of the friction time, the top of the AFM probe is worn away, and the probe radius gradually increases, resulting in an increase of the contact area. This prevents the electron beam from directly irradiating the contact region, thereby reducing the effect of the electron beam irradiation. This result may indicate that the effect of electron irradiation on the frictional force of the single-layer molybdenum disulfide is only effective near the irradiated region and could not be transmitted along the surface of the single-layer molybdenum disulfide. Therefore, when regulation the frictional force of the friction pair corresponding to the molybdenum disulfide subsequently, it is better to regulate the frictional force of the friction pair in the irradiated region.

After the frictional characteristic data of the molybdenum disulfide are obtained, it is then possible to proceed to step 103. Molybdenum disulfide is widely used as a soft metal, and it is art important solid lubricant especially suitable for high temperature and high pressure. It is also diamagnetic, can be used as a linear photoconductor and a semiconductor exhibiting P-type conductivity or exhibiting N-type conductivity, and has the functions of rectification and transduction. In the above applications, it is often required to acquire the frictional force of the friction pair corresponding to the molybdenum disulfide. For example, when the molybdenum disulfide is used as a solid lubricant on a device, it is required to regulate its frictional force to the target frictional force.

In an embodiment, the controlling the electron beam to irradiate the molybdenum disulfide based on the frictional characteristic data of the molybdenum disulfide, to regulate the frictional force of the friction pair corresponding to the molybdenum disulfide to the target frictional force includes:
regulating the accelerating voltage of the scanning electron microscope and the electron beam current of the scanning electron microscope based on the relationship between the frictional force data, and the accelerating voltage and the electron beam current until the frictional force of the friction pair corresponding to the molybdenum disulfide is equal to the target frictional force.

In the above embodiment, an electron beam control command may be generated based on the target frictional force, and the relationship between the relative frictional force of the single-layer molybdenum disulfide, and the accelerating voltage and the electron beam current which is shown in FIG. 6. The electron beam control command may include the accelerating voltage and the electron beam current both of which correspond to the target frictional force. The electron beam control command is transmitted to the scanning electron microscope. The electron beam emitter of the scanning electron microscope emits an electron beam based on the accelerating voltage and the electron beam current both of which are included in the electron beam control command, and at the same time, collects the frictional force of the friction pair corresponding to the molybdenum disulfide until the frictional force of the friction pair corresponding to the molybdenum disulfide is equal to the target frictional force.

Based on the above, in the method provided by the embodiment of the disclosure, the frictional force data of the friction pair corresponding to the molybdenum disulfide under the different electron beam irradiation conditions are acquired. The different electron beam irradiation conditions include different accelerating voltage conditions and different electron beam current conditions. The frictional characteristic data of the molybdenum disulfide are acquired based on the frictional force data of the friction pair corresponding to the molybdenum disulfide under the different electron beam irradiation conditions. After acquiring the target frictional force of the molybdenum disulfide, the electron beam is controlled to irradiate the molybdenum disulfide based on the frictional characteristic data of the molybdenum disulfide, to regulate the frictional force of the friction pair corresponding to the molybdenum disulfide to the target frictional force. In the above process, the frictional characteristic data of the molybdenum disulfide are acquired based on the frictional force data of the friction pair corresponding to the molybdenum disulfide under the different electron beam irradiation conditions; and then, after acquiring the target frictional force of the molybdenum disulfide each time, the electron beam can be controlled to irradiate the molybdenum disulfide based on the frictional characteristic data of the molybdenum disulfide, to regulate the frictional force of the friction pair corresponding to the molybdenum disulfide to the target frictional force. The implementation of the friction regulation process for molybdenum disulfide by irradiating the molybdenum disulfide with the electron beam is not interfered with the electrostatic force on the surface of the friction pair, so the regulation accuracy is high.

Based on the same inventive concept, an embodiment of the disclosure further provides a friction regulation apparatus for molybdenum disulfide, as described in the following embodiment. The principles for solving the problems are similar to those of the friction regulation method for molybdenum disulfide. Therefore, for the implementation of the apparatus, reference may be made to the implementation of the method, and the repetitions will not be described in detail.

FIG. 9 is a schematic diagram of a friction regulation apparatus for molybdenum disulfide according to an embodiment of the disclosure. As shown in FIG. 9, the apparatus includes:
a frictional force data acquisition module 901, which is configured to acquire frictional force data of a friction pair corresponding to the molybdenum disulfide under different electron beam irradiation conditions, and the different electron beam irradiation conditions including different accelerating voltage conditions and different electron beam current conditions;
a frictional characteristic data acquisition module 902, which is configured to acquire frictional characteristic data of the molybdenum disulfide based on the frictional force data of the friction pair corresponding to the molybdenum disulfide under the different electron beam irradiation conditions; and
a regulation module 903, which is configured to control, after acquiring a target frictional force of the molybdenum disulfide, an electron beam to irradiate the molybdenum disulfide based on the frictional characteristic data of the molybdenum disulfide, to regulate a frictional force of the friction pair corresponding to the molybdenum disulfide to the target frictional force.

In an embodiment, the friction pair corresponding to the molybdenum disulfide is a friction pair formed between the molybdenum disulfide and an atomic force microscope probe.

In an embodiment, the frictional force data acquisition module 901 is specifically configured to:
acquire a plurality of sets of electron beam irradiation conditions;
control, for each set of electron beam irradiation conditions, an accelerating voltage of a scanning electron microscope and an electron beam current thereof to meet the set of electron beam irradiation conditions; and
acquire, when the atomic force microscope probe moves at a set scanning speed on a surface of the molybdenum disulfide, the frictional force data between the molybdenum disulfide and the atomic force microscope probe under each set of electron beam irradiation conditions.

In an embodiment, the frictional characteristic data of the molybdenum disulfide includes a relationship between the frictional force data, and the accelerating voltage and the electron beam current.

The frictional characteristic data acquisition module 902 is specifically configured to:
obtain the relationship between the frictional force data, and the accelerating voltage and the electron beam current based on the frictional force data between the molybdenum disulfide and the atomic force microscope probe under the plurality of sets of electron bean irradiation conditions.

In an embodiment, the regulation module 903 is specifically configured to:
regulate the accelerating voltage of the scanning electron microscope and the electron beam current of the scanning electron microscope based on the relationship between the frictional force data, and the accelerating voltage and the electron beam current until the frictional force of the friction pair corresponding to the molybdenum disulfide is equal to the target frictional force.

In an embodiment, the molybdenum disulfide is single-layer molybdenum disulfide.

Based on the above, in the apparatus provided by the embodiment of the disclosure, the frictional force data of the friction pair corresponding to the molybdenum disulfide under the different electron beam irradiation conditions are acquired. The different electron beam irradiation conditions include different accelerating voltage conditions and different electron beam current conditions. The frictional characteristic data of the molybdenum disulfide are acquired based on the frictional force data of the friction pair corresponding to the molybdenum disulfide under the different electron beam irradiation conditions. After acquiring the target frictional force of the molybdenum disulfide, the electron beam is controlled to irradiate the molybdenum disulfide based on the frictional characteristic data of the molybdenum disulfide, to regulate the frictional force of the friction pair corresponding to the molybdenum disulfide to the target frictional force. In the above process, the frictional characteristic data of the molybdenum disulfide are acquired based on the frictional force data of the friction pair corresponding to the molybdenum disulfide under the different electron beam irradiation conditions; and then, after acquiring the target frictional force of the molybdenum disulfide each time, the electron beam can be controlled to irradiate the molybdenum disulfide based on the frictional characteristic data of the molybdenum disulfide, to regulate the frictional force of the friction pair corresponding to the molybdenum disulfide to the target frictional force. The implementation of the friction regulation process for molybdenum disulfide by irradiating the molybdenum disulfide with the electron beam is not interfered with the electrostatic force on the surface of the friction pair, so the regulation accuracy is high.

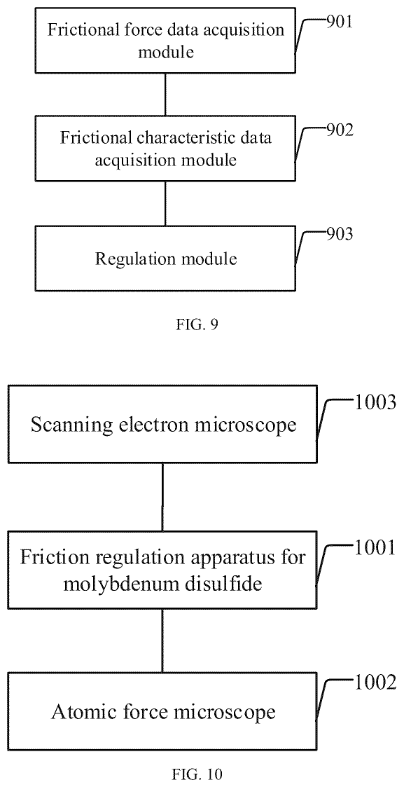

An embodiment of the disclosure further provides a friction regulation system for molybdenum disulfide. FIG. 10 is a schematic diagram of the friction regulation system for molybdenum disulfide according to an embodiment of the disclosure. The system includes: the friction regulation apparatus for molybdenum disulfide 1001, an atomic force microscope 1002 and a scanning electron microscope 1003.

The atomic force microscope 1002 is configured to acquire frictional force data between the molybdenum disulfide and an atomic force microscope probe under different electron beam irradiation conditions by moving the atomic force microscope probe on a surface of the molybdenum disulfide at a set scanning speed, and send the frictional force data to the friction regulation apparatus for molybdenum disulfide.

The scanning electron microscope 1003 is configured to receive an electron beam control command and emit an electron beam according to the electron beam control command. The electron beam control command includes different electron beam irradiation conditions.

The friction regulation apparatus for molybdenum disulfide 1001 is further configured to send the electron beam control command to the atomic force microscope and receive the frictional force data.

In the system, the friction regulation apparatus for molybdenum disulfide acquires the accelerating voltage and the electron beam current both of which correspond to the target frictional force based on the target frictional force of the molybdenum disulfide and the relationship between the frictional force data, and the accelerating voltage and the electron beam current, generates the electron beam control command and sends the electron beam control command to the scanning electron microscope 1003. Then, the scanning electron microscope 1003 can emit the electron beam according to the electron beam control command.

The system provided by the embodiment of the disclosure includes the friction regulation apparatus for molybdenum disulfide. Therefore, the frictional characteristic data of the molybdenum disulfide can be acquired based on the frictional force data of the friction pair corresponding to the molybdenum disulfide under the different electron beam irradiation conditions; and then, after acquiring the target frictional force of the molybdenum disulfide each time, the electron beam can be controlled to irradiate the molybdenum disulfide based on the frictional characteristic data of the molybdenum disulfide, to regulate the frictional force of the friction pair corresponding to the molybdenum disulfide to the target frictional force. The implementation of the friction regulation process for molybdenum disulfide by irradiating the molybdenum disulfide with the electron beam is not interfered with the electrostatic force on the surface of the friction pair, so the regulation accuracy is high.

It should be understood by those skilled in the art that the embodiments of the disclosure can be provided as methods, systems or computer program products. Therefore, the disclosure may take the form of a complete hardware embodiment, a complete software embodiment, or an embodiment combining software and hardware aspects. Moreover, the disclosure may take the form of a computer program product implemented on one or more computer usable storage medium (including but not limited to disk memories, CD-ROMs, optical memories, etc.) including computer usable program codes therein.

The disclosure is described with reference to flowcharts and/or block diagrams of the method, apparatus (system) and computer program product according to the embodiments of the disclosure. It should be understood that each flow and/or block in the flowcharts and/or block diagrams, and combinations of the flows and/or blocks in the flowcharts and/or block diagrams can be implemented by computer program instructions. These computer program instructions may be provided to a processor of one selected from the a general-purpose computer, a special-purpose computer, an embedded processor and another programmable data processing device to produce a machine, such that an apparatus for implementing functions specified in one or more flows in the flowchart and/or one or more blocks in the block diagram is generated by means of the instructions executed by the processor of the computer or another programmable data processing device.

These computer program instructions may also be stored in a computer-readable memory that can direct a computer or other programmable data processing devices to operate in a particular manner, such that the instructions stored in the computer-readable memory produce a manufacture including an instruction apparatus, and the instruction apparatus implements the functions specified in one or more flows in the flowchart and/or one or more blocks in the block diagram.

These computer program instructions may also be loaded to a computer or other programmable data processing devices, such that a series of operation steps are executed on the computer or other programmable devices to produce computer-implemented processing, such that the instructions executed on the computer or other programmable devices provide steps for implementing the functions specified in one or more flows in the flowchart and/or one or more blocks in the block diagram.

The specific embodiments described above have further illustrate the objectives, technical solutions and beneficial effects of the disclosure in detail. It should be understood that the above is merely specific embodiments of the disclosure, and is not intended to limit the protection scope of the disclosure. Any modification, equivalent substitution, improvement, etc. made within the spirit and principle of the disclosure shall fall within the protection scope of the disclosure.

1. A friction regulation method for molybdenum disulfide, comprising:
acquiring frictional force data of a friction pair corresponding to the molybdenum disulfide under different electron beam irradiation conditions, wherein the different electron beam irradiation conditions comprises different accelerating voltage conditions and different electron beam current conditions;
acquiring frictional characteristic data of the molybdenum disulfide based on the frictional force data of the friction pair corresponding to the molybdenum disulfide under the different electron beam irradiation conditions; and
controlling, after acquiring a target frictional force of the molybdenum disulfide, an electron beam to irradiate the molybdenum disulfide based on the frictional characteristic data of the molybdenum disulfide, to regulate a frictional force of the friction pair corresponding to the molybdenum disulfide to the target frictional force.

2. The friction regulation method for molybdenum disulfide according to claim 1, wherein the friction pair corresponding to the molybdenum disulfide is a friction pair formed between the molybdenum disulfide and an atomic force microscope probe.

3. The friction regulation method for molybdenum disulfide according to claim 2, wherein the acquiring the frictional force data of the friction pair corresponding to the molybdenum disulfide under the different electron beam irradiation conditions comprises:
acquiring a plurality of sets of electron beam irradiation conditions;
controlling, for each set of electron beam irradiation conditions, an accelerating voltage of a scanning electron microscope and an electron beam current thereof to meet the set of electron beam irradiation conditions; and
acquiring, when the atomic force microscope probe moves at a set scanning speed on a surface of the molybdenum disulfide, the frictional force data between the molybdenum disulfide and the atomic force microscope probe under each set of electron beam irradiation conditions.

4. The friction regulation method for molybdenum disulfide according to claim 3, wherein the frictional characteristic data of the molybdenum disulfide comprises a relationship between the frictional force data and the accelerating voltage and the electron beam current; and
the acquiring the frictional characteristic data of the molybdenum disulfide based on the frictional force data of the friction pair corresponding to the molybdenum disulfide under the different electron beam irradiation conditions comprises;
obtaining the relationship between the frictional force data and the accelerating voltage and the electron beam current based on the frictional force data between the molybdenum disulfide and the atomic force microscope probe under the plurality of sets of electron beam irradiation conditions.

5. The friction regulation method for molybdenum disulfide according to claim 4, wherein the controlling the electron beam to irradiate the molybdenum disulfide based on the frictional characteristic data of the molybdenum disulfide, to regulate the frictional force of the friction pair corresponding to the molybdenum disulfide to the target frictional force comprises:
regulating the accelerating voltage of the scanning electron microscope and the electron beam current thereof based on the relationship between the frictional force data and the accelerating voltage and the electron beam current, until the frictional force of the friction pair corresponding to the molybdenum disulfide is equal to the target frictional force.

6. The friction regulation method for molybdenum disulfide according to claim 1, wherein the molybdenum disulfide is single-layer molybdenum disulfide.

7. A friction regulation apparatus for molybdenum disulfide, comprising:
a frictional force data acquisition module configured to acquire frictional force data of a friction pair corresponding to the molybdenum disulfide under different electron beam irradiation conditions, wherein the different electron beam irradiation conditions comprises different accelerating voltage conditions and different electron beam current conditions;
a frictional characteristic data acquisition module configured to acquire frictional characteristic data of the molybdenum disulfide based on the frictional force data of the friction pair corresponding to the molybdenum disulfide under the different electron beam irradiation conditions; and
a regulation module configured to control, after acquiring a target frictional force of the molybdenum disulfide, an electron beam to irradiate the molybdenum disulfide based on the frictional characteristic data of the molybdenum disulfide, to regulate a frictional force of the friction pair corresponding to the molybdenum disulfide to the target frictional force.

8. A friction regulation system for molybdenum disulfide, comprising: a friction regulation apparatus for molybdenum disulfide, an atomic force microscope, and a scanning electron microscope, wherein
the atomic force microscope is configured to acquire frictional force data between the molybdenum disulfide and an atomic force microscope probe under different electron beam irradiation conditions by moving the atomic force microscope probe on a surface of the molybdenum disulfide at a set scanning speed, and send the frictional force data to the friction regulation apparatus for molybdenum disulfide;
the scanning electron microscope is configured to receive an electron beam control command and emit an electron beam according to the electron beam control command, wherein the electron beam control command comprises different electron beam irradiation conditions; and
the friction regulation apparatus for molybdenum disulfide is further configured to send the electron beam control command to the atomic force microscope and receive the frictional force data,
wherein the friction regulation apparatus for molybdenum disulfide comprises:
a frictional force data acquisition module configured to acquire frictional force data of a friction pair corresponding to the molybdenum disulfide under different electron beam irradiation conditions, wherein the different electron beam irradiation conditions comprises different accelerating voltage conditions and different electron beam current conditions;
a frictional characteristic data acquisition module configured to acquire frictional characteristic data of the molybdenum disulfide based on the frictional force data of the friction pair corresponding to the molybdenum disulfide under the different electron beam irradiation conditions; and
a regulation module configured to control, after acquiring a target frictional force of the molybdenum disulfide, an electron beam to irradiate the molybdenum disulfide based on the frictional characteristic data of the molybdenum disulfide, to regulate a frictional force of the friction pair corresponding to the molybdenum disulfide to the target frictional force.

9-10. (canceled)
